(19) United States
(12) Patent Application Publication
(10) Pub. No.: US 2017/0282658 A1
(43) Pub. Date: Oct. 5, 2017

(54) TRAILER COUPLING SYSTEM

(71) Applicant: Daniel Robert Shepard, Stratham, NH (US)

(72) Inventor: Daniel Robert Shepard, Stratham, NH (US)

(21) Appl. No.: 15/477,114

(22) Filed: Apr. 2, 2017

Related U.S. Application Data
(60) Provisional application No. 62/317,535, filed on Apr. 2, 2016.

(51) Int. Cl. B60D 1/58; B62D 15/02

(52) U.S. Cl. CPC B60D 1/58; B62D 15/024; B62D 15/029; B62D 15/028; B62D 15/0275

(57) ABSTRACT

The present invention relates to systems for guiding a vehicle to a trailer that can easily be installed or removed, and in particular relates to systems for guiding a vehicle to a trailer to facilitate coupling the vehicle and trailer together. The present invention is a means and a method for continuously determining the heading and/or distance to the trailer to assist a driver to couple a vehicle and trailer together. A device containing an inertial measurement unit is manually positioned proximate to the hitch ball of the vehicle and then positioned proximate to the coupler of the trailer and the motion is tracked and stored to enable the desired path between the two positions to be plotted. This path is then used to guide the driver in bringing the hitch ball and coupler together.

### CROSS-REFERENCE TO RELATED APPLICATION

This Patent Application makes reference to and claims the benefit of U.S. Provisional Patent Application 62/317,535 by Shepard titled “TRAILER COUPLING SYSTEM” that was filed on Apr. 2, 2016 and that application is incorporated herein in its entirety by reference.

### TECHNICAL FIELD

In various embodiments, the present invention relates to systems for trailers and, in particular, the present invention relates to systems for vehicles to back up to and couple with a trailer.

### BACKGROUND

Trailers have been around for many years, yet every summer and winter one can observe the owners of boats and snowmobiles, respectively, backing up their vehicles with great difficulty. One problem arises from the fact that a coupled trailer being backed-up is an inherently unstable system. A trailer being pushed wants to turn around and be pulled (i.e., to jackknife) instead. But, another problem arises when a vehicle needs to be connected or coupled to a detached trailer. The driver must backup the vehicle such that the hitch on the vehicle is positioned proximate to the trailer such that the vehicle and trailer can be coupled together, but the hitch ball on the vehicle and the coupler on the trailer are typically not visible to the driver. One solution has been to have an assistant who, using verbal commands and hand gestures, directs the driver in how far and in which direction he or she should back up the vehicle in order to align the hitch ball to the coupler. Another approach disclosed in U.S. Pat. No. 8,138,899 by Ghneim involves positioning a video system such that both the hitch ball and the trailer's coupler are visible on a screen accessible to the driver. However, not all drivers have access to a proficient assistant or a viable video system.

### SUMMARY

The present invention relates to systems for guiding a vehicle to a trailer that can easily be installed or removed, and in particular to systems for guiding a vehicle to a trailer to facilitate coupling the vehicle and trailer together. The present invention is a means and a method for continuously determining the direction and/or distance to the trailer to assist a driver to couple a vehicle and trailer together.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawing, in which:

FIG. 1 depicts a hitch ball that would be attached to the rear of a vehicle.

FIG. 2 depicts a coupler that would be found on the tongue of a trailer.

FIG. 3 depicts an IMU device being used to plot a path for a vehicle in accordance with various embodiments of the invention.

FIG.4 depicts a possible display device in accordance with the present invention.

### DETAILED DESCRIPTION

A challenge in trailering second to backing up with the trailer attached is coupling the unattached trailer to the vehicle. The vehicle (on which a hitch is mounted) must be backed up to the trailer's coupler (which is on the end of the trailer's tongue) very precisely. This is often done with an assistant. The assistant must verbally direct the driver of the vehicle in how far to back up and in what direction to turn to bring the hitch ball into proper alignment for coupling. Such verbal directing can be a challenge. However, the present invention can provide the driver with all the direction and distance information required for coupling a trailer without an assistant.

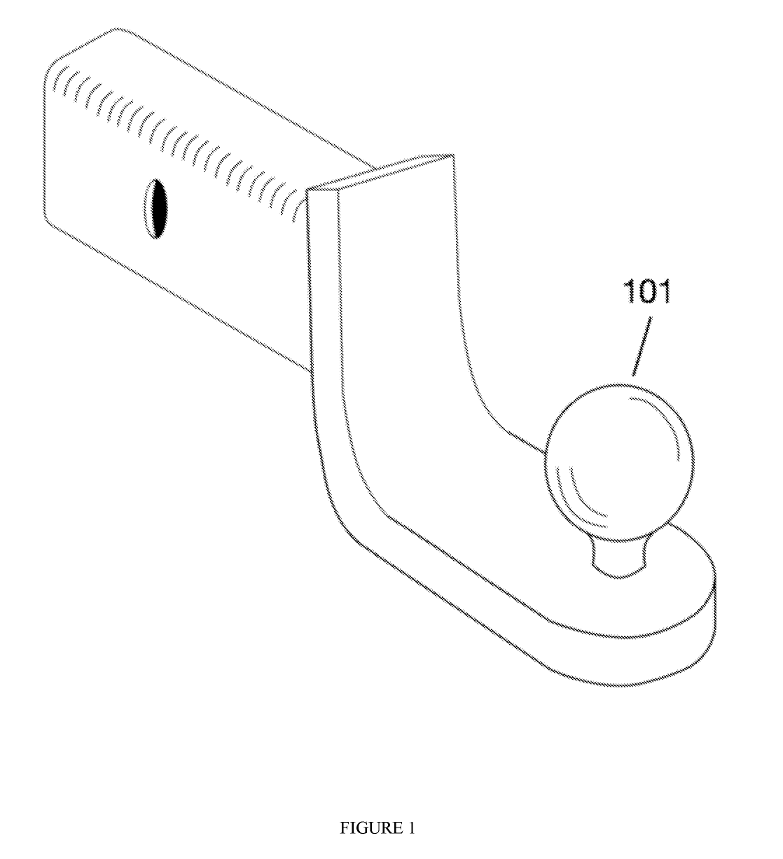

The present invention relates to systems for guiding a driver in backing up a trailer for guiding a hitch ball to the proper location of a trailer tongue for coupling the hitch and trailer together. FIG. 1 illustrates a typical hitch ball mount with a hitch ball 101 mounted. The hitch ball 101 is typically a solid metal sphere with a stem extending from the bottom of the ball and whereby the bottom portion of the stem is threaded. The hitch ball mount has a corresponding hole through it to enable inserting the threaded stem to pass through the hitch ball mount and be secured from below with a hitch ball nut. The hitch ball mount is inserted in the hitch attached to the back of a tow vehicle.

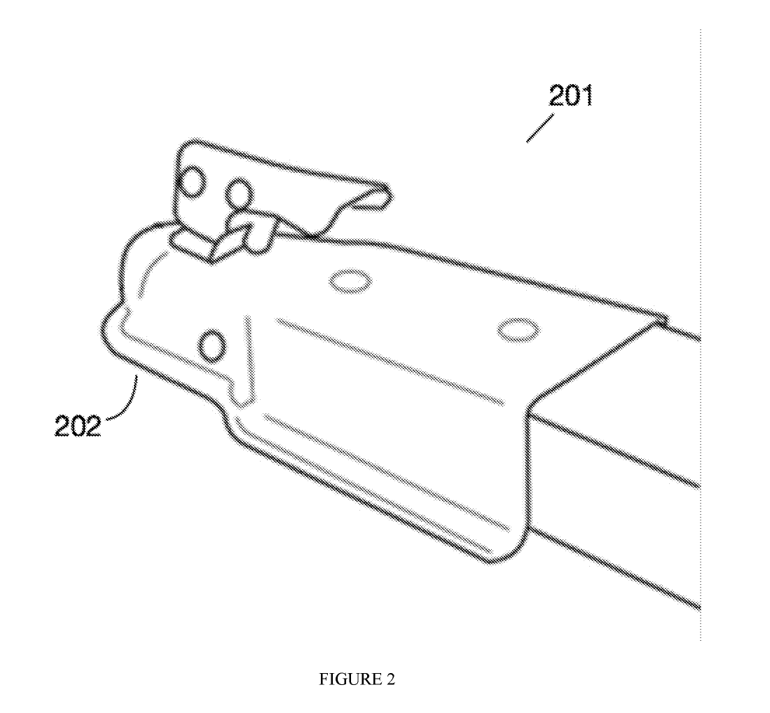

FIG. 2 illustrates a typical coupler 201 that would be found on the tongue of a trailer. This coupler 201 has a spherical space 202 wherein the hitch ball can be locked to effect vehicle to trailer coupling. Since the trailer is often too heavy to position manually, to couple a vehicle to a trailer, the vehicle must be driven such that the hitch ball 101 is positioned directly below the spherical space 202 of the trailer's coupler 201.

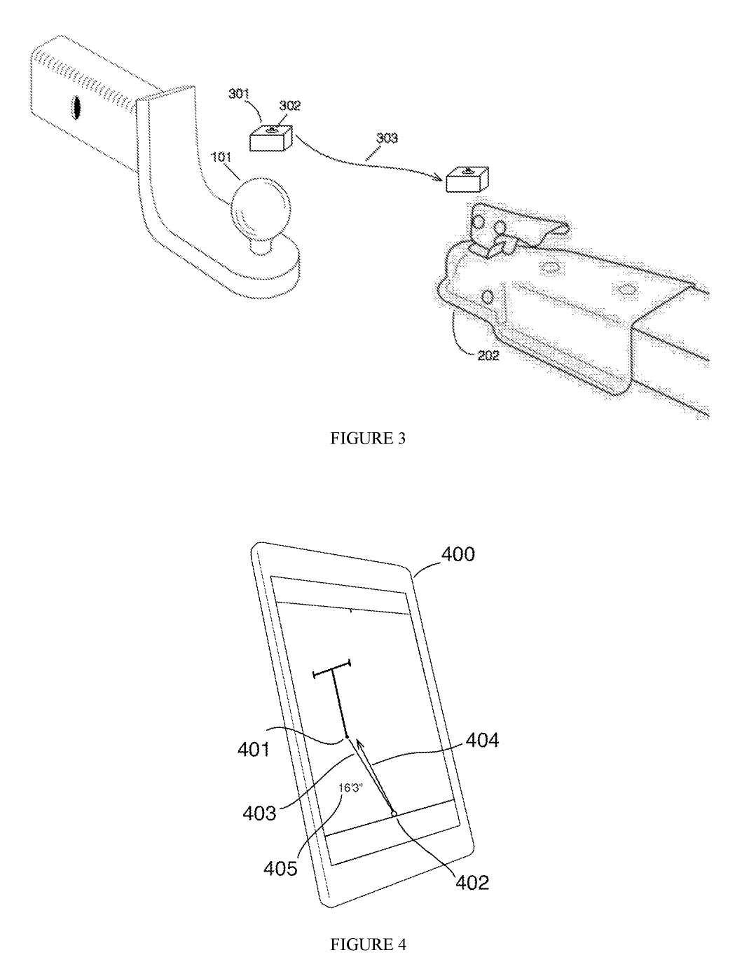

Refer now to FIG. 3. A small boxed device 301 comprises an inertial measurement unit (IMU) that has 9 degrees of freedom (9-DOF), a microprocessor, and communication circuitry. This communications circuitry can be wired, but is better implemented with a standard wireless communication mechanism (i.e., hardware, firmware and/or software) such as Bluetooth, Zigbee, WiFi, or cellular or some other communications protocol. This device 301 is battery powered to prevent a power cord from interfering with the process described below (however, if the power cord is long enough to cover the distance between the vehicle and the trailer, the device 301 could be powered from the vehicle). For example, the device 301 could comprise an nRF52 microprocessor with Bluetooth from Nordic Semiconductor.

To guide the vehicle to an uncoupled trailer for the purpose of coupling that trailer and vehicle together, device 301 would be positioned by hand proximate to the hitch ball; ideally, device 301 would be positioned directly on top of the hitch ball and with the centerline of the device 301 colinear with the centerline of the vehicle (i.e., the device 301 and the vehicle are pointing in the same direction). Once so positioned, a button 302 (or other input mechanism, such as a touch input on a smartphone or tablet connected to the device 301 via Bluetooth) is operated to signal the circuitry within the device 301 that an initial position has been effected. The device would then be walked along a path 303 to the trailer's coupler where the device would be positioned by hand proximate to the trailer's coupler; ideally, device 301 would be positioned directly on top of the spherical space 202 of the coupler and the centerline of the device 301 is colinear with the centerline of the trailer (i.e., the device 301 and the trailer are now pointing in the same direction). Once so positioned, the button 302 is again operated to indicate the device 301 is now located at the trailer's coupler.

As is well known by those skilled in the art of IMU's, a device 301 having an IMU and a microprocessor can be used to plot a path and that path can be recorded in the device. The path recording is initialized with the first button press and continues until the second button press. At this point, a path for the hitch ball to travel from its initial resting point to where it can be coupled to the trailer is stored in the device 301. This path can then be used to direct the vehicle operator so as to drive the vehicle and cause the hitch ball to replicate the path travelled by device 301 between the two button presses. At a minimum path, the starting point and ending point would be utilized to determine and store the heading and distance from the hitch ball to the coupler.

Once the path 303 (or the heading and distance) has been recorded in this way, device 301 (or an equivalent device that is in communication with device 301) can be mounted on the vehicle above the hitch ball. Alternatively, the device could be placed on or inside the vehicle, but trigonometric geometry would then be utilized to determine its location in the vehicle relative to the hitch ball and transform its position to that of the hitch ball. Device 301 will now monitor the difference between the initial position of the hitch ball and the current position of the hitch ball and continuously recompute the heading and the distance from the hitch ball to the trailer's coupler.

A display (as depicted in FIG. 4) will show this heading and distance graphically on a display device 400 such as an electronic display, a smartphone or a tablet that is in communications with the device 301. To effect coupling, the device 301 (now mounted above the hitch ball or on or in the vehicle) must be signaled a third time (via the button or a touch on the display device) that the coupling process is about to start (while the vehicle is still in the position it was in when the first button press occurred). The IMU generated path that is stored in the device 301 comprises the heading of the vehicle in its initial position and the heading of the trailer as well as the distance between the hitch ball and coupler and the direction to the coupler (measured relative to the initial heading of the vehicle). With the device 301 mounted above the hitch ball, as the driver backs up the vehicle, the IMU in device 301 continuously measures changes in heading and distance travelled since the third signaling press and calculates a new heading and distance to the trailer. The heading and distance to the trailer is continuously updated on the display 400 in this way such that the driver always knows the direction and distance to drive in order to effect coupling. The driver of the vehicle can see on the display 400 the direction 403 and a value for distance 405 to the trailer's coupler 403. The heading of the vehicle can also be depicted as a line 404 on the display. The driver can now look at the screen and back up the vehicle's hitch ball (depicted on the display as circle 402) to the trailer's coupler (depicted on the display as circle 401) by steering the vehicle to keep the heading line 404 collinear with the line 403 depicting the direction to the trailer and by slowing to a stop as the distance value 405 approaches zero.

It must be noted that when tracing a path with a 9-DOF IMU, the readings from the accelerometers will require a double integration of the data (first to arrive at velocity and second to arrive at distance). Therefore, as is understood by those skilled in the art, the accelerometers will have to be highly calibrated and the time required to couple the vehicle to the trailer must be kept very short because the integration error grows (nonlinearly at an increasing rate) with time. If necessary, to keep the time interval short, the operation could be broken up into two or more shorter operations (where each operation would involve recording the path and backing the vehicle to partially close the gap until coupling can be achieved). Alternatively, as is also known to those skilled in the art, additional orientation reference information can be obtained using additional circuitry hardware and or software to collect GPS data or radio triangulation or even imaging the surrounding area and tracking visually recognizable reference points; all of these techniques for improving the precision of dead reckoning are known to those skilled in the art. Other alternative approaches include sensors to measure wheel rotation at the tires that, along with the circumference of the tire, can measure the actual distance covered rather than utilizing the double integration of the accelerometer; in this approach, the direction is measured by the gyroscopes in the IMU and the distance travelled is determined by multiplying the circumference of the tire by the tire's rotation as measured by the tire sensors (or by other means to determine wheel rotation). Utilizing tire sensors on both sides of the vehicle and averaging the distance travelled on both sides of the vehicle will yield a distance travelled for the hitch ball.

For vehicles having automated steering, an automatic system can be implemented. In an automated system, the operator could operate the accelerator and break (or the vehicle could control the accelerator and break) while the IMU device continuously updates the direction and distance to drive in order to effect coupling; this latter possibility of a self-driving vehicle is well known to those skilled in the art and has been demonstrated by such companies as Google.

The key for assisted trailer coupling of any kind is to (i) steer the vehicle (either automatically or by providing the driver a display means as part of a feedback loop such that the driver can adjust and maintain a direction) such that the predicted path of the vehicle (or, more specifically, the path of the hitch ball mounted on the vehicle) reaches the point of the trailer tongue's coupler, (ii) control the accelerator of the vehicle, and (iii) control the breaks of the vehicle such that the vehicle can be moved along that path whereby hitch ball mounted on the vehicle will come to rest at the point where trailer tongue's coupler is positioned.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

I claim:

1. A method for guiding a vehicle to a trailer for the purpose of coupling comprising the steps of (i) providing a device comprising an IMU and a processor that is able to record data,
(ii) positioning the device such that it is proximate to the hitch ball of the vehicle,
(iii) utilizing the IMU to record an initial value for a heading from step ii, (iv) positioning the device proximate to the trailer's coupler, (v) utilizing the IMU to determine a distance and direction from the position in step ii to the position in step iv, (vi) determining a change in the distance and direction from the hitch ball of the vehicle to the trailer's coupler as the vehicle reverses, (vii) determining a new distance and direction by adjusting the distance and direction determined in step v by the change in the distance and direction determined in step vi.

2. The method of claim 1 further comprising the step of graphically showing the adjusted distance and direction determined in step vii on a display.

3. The method of claim 2 further comprising the step of manually operating the steering, accelerator and breaking of the vehicle based on the graphical display.

4. The method of claim 1 further comprising automatically operating the steering of the vehicle based on the adjusted distance and heading determined in step vii.

5. The method of claim 4 further comprising the step of manually operating the accelerator and breaking of the vehicle.

6. The method of claim 4 further comprising the step of automatically operating one or more of the accelerator and breaking of the vehicle.

7. The display of claim 2 being one or more of an electronic display, a smartphone, a tablet.

8. The display of claim 2 further comprising a wireless connection to the device comprising the IMU.

9. The wireless connection of claim 8 comprising a communications protocol selected from the list of communications protocols comprising Bluetooth, zigbee, WiFi, or cellular.

10. The method of claim 1 further comprising collecting additional orienting information using circuitry, software, or both to provide GPS data, radio triangulation, or imaging data.

11. The method of claim 1 further comprising determining a tire's rotation.

12. The method of claim 11 further comprising determining distance by multiplying the tire's rotation by the circumference of the tire.

13. The method of claim 1 further comprising determining a new distance and direction by adjusting the prior new distance and direction by a new change in the distance and direction determined in step vi.
